(19) United States
(12) Patent Application Publication
(10) Pub. No.: US 2015/0280815 A1
(43) Pub. Date: Oct. 1, 2015

(54) OPTICAL COMMUNICATION APPARATUS CONTROLLING RECEIVED OPTICAL INTENSITY WITH GAIN-SWITCHABLE OPTICAL AMPLIFIER

(71) Applicant: Oki Electric Industry Co., Ltd., Tokyo (JP)

(72) Inventor: Shuko KOBAYASHI, Tokyo (JP)

(73) Assignee: Oki Electric Industry Co., Ltd., Tokyo (JP)

(21) Appl. No.: 14/575,524

(22) Filed: Dec. 18, 2014

(30) Foreign Application Priority Data
Mar. 26, 2014 (JP) 2014-063808

(51) Int. Cl. H04B 10/079

(52) U.S. Cl. CPC H04B 10/0795

(57) ABSTRACT

In an optical network unit, an optical-intensity monitor monitors the received optical intensity of a received light beam input thereto, and a controller uses the received optical intensity to produce an intensity control signal, in response to which a semiconductor optical amplifier selectively amplifies or attenuates the optical intensity of the received light to produce an intensity-adjusted light beam, which a receiver can receive within its receivable-intensity range.

### BACKGROUND OF THE INVENTION

1. Field of the Invention

The present invention relates to an optical communication apparatus, and in particular to an optical communication apparatus controlling the gain of a received signal in response to received optical intensity.

2. Description of the Background Art

In recent years, with progress in spread of the Internet, there is a rapidly growing demand for telecommunications. Correspondingly, optical access networks of high speed with large capacity, using optical fiber or the like, are being prepared. In order to accomplish high-speed and large-capacity transmission in such optical access networks, multiplex transmission is indispensable. As multiplex transmission schemes, the optical time division multiplexing (OTDM) and the wavelength division multiplexing (WDM) are being put into practical use, and research on optical code division multiplexing (OCDM) is actively carried out.

In correspondence to preparation for such optical access networks, services are diversifying. Since requirements for optical access networks may be different service by service, there may often be the case that optical access networks are specifically designed service by service. Consequently, there may be newly installed optical access networks among existing networks, both of which provide different services from each other. As a result, in order to cope with added services, costs increase for introducing an optical access network and management thereof.

Under such circumstances, an optical access network is called for which is capable of easily adding and removing services as well as efficiently consolidating the requirements for the optical access network that may specifically be different service by service.

As a solution to implement such optical access networks, attention is received by a coherent optical orthogonal frequency division multiplexing (CO-OFDM), which applies the OFDM prevalent in wireless communications to optical fiber transmission.

The OFDM is a multicarrier transmission system digitally modulating plural carrier waves that are orthogonal to each other to multiplex them. The digital modulation may be combined with, for example, a multivalued modulation scheme, such as quadrature phase shift keying (QPSK) or quadrature amplitude modulation (QAM), thus accomplishing the maximum use of limited bandwidths. In other words, since a bandwidth required for transmitting the same amount of information can be minimized, it is possible to easily add and remove services to and from the system. Further, such a system also makes it possible to specifically design its transmission capacity and bandwidth service by service, thus allowing different services to be efficiently consolidated.

When setting up an optical access network, designing of tolerable loss values, so-called loss budget, may become critical since losses may be caused such as transmission loss in optical fiber, branching loss in optical couplers and wavelength filters, and loss due to various intervening optical devices or the like.

Transmission loss in optical fiber is generally in the order of 0.2 dB/km and branch loss in optical couplers is 3 dB, for example. The longer transmission distance and/or the more branches, the more attenuation in transmission signal. For example, in a 16-user network configured by the bus topology, a subscriber terminal, i.e. an optical network unit (ONU), which is located nearest a station terminal, i.e. an optical line terminal (OLT), is connected only via one optical coupler so that it has its branch loss of 3 dB whereas an ONU, which is located farthest from the OLT, is connected via 15 optical couplers so that the branch loss is 45 dB. As described above, the amount of loss due to branching differs by 42 dB between the ONU nearest the OLT and the ONU farthest from the OLT. Further, the amount of loss due to transmission also differs between the ONU nearest the OLT and the ONU farthest therefrom.

In general, an optical receiver has its optical-intensity receivable range confined not only by the lower limit but also the upper limit. Consequently, the receiver may fail to receive an optical signal not only when the optical signal is too weak but also when too strong. In the following, description will be made on an example where a 16-user network configured on bus topology includes ONUs each of which has its optical-intensity receivable range of −30 dBm to −20 dBm.

Focusing on the branching loss caused by an optical coupler when the intensity, or power, of an output optical signal from the OLT is 0 dBm, the optical intensity received by an ONU farthest from the OLT is −45 dBm, and hence the ONU farthest from the OLT cannot receive the optical signal from the OLT because of the received optical intensity being too weak. By contrast, the optical intensity received by another ONU nearest the OLT is −3 dBm, and hence the ONU nearest the OLT also cannot receive the optical signal from the OLT because of the received optical intensity being too strong.

For example, U.S. Pat. No. 8,121,486 to Tetsuya Uda, et al., teaches a conventional receiving apparatus included in an ONU and adapted to properly receive optical signals when the ONU is installed at any locations in an optical network. The receiving apparatus comprises an optical amplifier and an optical attenuator which are provided as stages prior to an optical receiver to thereby adaptively adjust optical intensity.

More specifically, the receiving apparatus includes a controller adapted to be responsive to the optical intensity of a received light beam measured by an optical-intensity meter to control the gain of the optical amplifier and the attenuation rate of the optical attenuator. When the GNU is installed near the OLT so that the received optical intensity becomes stronger, for example, the optical attenuator is enabled to attenuate the optical intensity of the received light beam, whereas, when the ONU is installed farther from the OLT so that the received optical intensity becomes weaker, the optical amplifier is enabled to enhance the optical intensity of the received light beam.

However, the prior art receiving apparatus described above includes, for the purpose of controlling the optical intensity of light received in an ONU, the optical amplifier and an optical attenuator that are optical intensity control devices, thereby increasing costs for those components and electric power consumed by the components.

In the prior art receiving apparatus, in order to increase the gain, there is used an erbium-doped optical fiber amplifier (EDFA) using optical fiber having its core doped with erbium ion to attain its amplification up to 50 dB or more. When the EDFA is used as an optical amplifier, a certain amount of current has to be conducted in order to conduct an optical beam even when there is no need for amplification. Consequently, when light is attenuated, electric power may be consumed not only in the optical attenuator but also in the optical amplifier.

Moreover, due to the characteristics and conditions of optical devices through which optical signals pass and the condition of the transmission path, the intensity of received light in ONUs may not be constant. That requires the attenuation rate of the optical attenuator and the gain of the optical amplifier to be appropriately adjusted. When the number of branches and transmission distance in an optical access network increase, the required number of optical intensity control devices increases accordingly, which causes an increase in cost required for the adjustment.

As the result of close examination, the inventor of the present application has conceived an idea that the problems described above can be solved by utilizing such nature of semiconductor optical amplifiers that they function as attenuators in a region of small current conducted.

### SUMMARY OF THE INVENTION

It is therefore an object of the present invention to provide an optical communication apparatus for controlling received optical intensity, or power, without using a number of optical intensity control devices.

In accordance with the present invention, an optical communication apparatus comprises an optical-intensity monitor monitoring the received optical intensity of an incoming light beam, a controller operative in response to the received optical intensity for producing an intensity control signal, an optical amplifier having a variable gain for the optical intensity of the incoming light beam in response to the intensity control signal to develop an intensity-adjusted light beam, and a receiver having a receivable-intensity range for receiving the intensity-adjusted light beam from the semiconductor optical amplifier within the receivable-intensity range.

Preferably, the optical amplifier may comprise a semiconductor optical amplifier (SOA) operative in response to the intensity control signal for selectively amplifying or attenuating the optical intensity of the incoming light beam to develop the intensity-adjusted light beam. Also preferably, the semiconductor optical amplifier may exhibit positive or negative gain depending on current applied thereto.

In a preferred embodiment of the optical communication apparatus in accordance with the present invention, the controller may be constituted in such a way that it holds data representing applied-current vs gain characteristic of the semiconductor optical amplifier and calculates a gain value for appropriately adjusting the received optical intensity so as to fall within an optical intensity range receivable by the receiver. Based on the applied-current vs gain characteristic data, the controller supplies the semiconductor optical amplifier with the applied current as the intensity control signal.

In accordance with the optical communication apparatus of the present invention, since an optical-intensity control device for use in receiving optical signals is solely the single optical amplifier, such as an SOA, the number of constituent elements and electric consumption can be reduced, compared to the prior art optical communication apparatus using plural optical-intensity control devices.

Further, since the intensity of optical signals received by the receiver of the optical communication apparatus is dependent upon the magnitude of current applied to the optical amplifier, control becomes easier than the prior art apparatus requiring control of current applied to both optical amplifier and attenuator. The optical communication apparatus in accordance with the invention is advantageously suitable for use in subscriber terminals of optical access networks.

### BRIEF DESCRIPTION OF THE DRAWINGS

The objects and features of the present invention will become more apparent from consideration of the following detailed description taken in conj unction with the accompanying drawings in which:

FIG. 1 is a schematic block diagram of an optical access network configured on the basis of bus topology;

FIG. 2 schematically shows, in a block diagram, the configuration of an illustrative embodiment of optical communication apparatus according to the present invention; and

FIG. 3 is a graph plotting the measurements of the gain characteristic of the semiconductor optical amplifier shown in FIG. 2.

### DESCRIPTION OF THE PREFERRED EMBODIMENT

In the following, an illustrative embodiment in accordance with the present invention will be described with reference to the accompanying drawings. The shape, size and relative location of the constituent elements will be shown and described just in a schematic fashion to the extent allowing the present invention to be understandable. Signals and data will be indicated with reference numerals for connections on which they appear. Also, in the following, a preferred embodiment in accordance with the present invention will be described, of which the constituent elements are implemented by specific materials and numerical requirements, which are just for illustration.

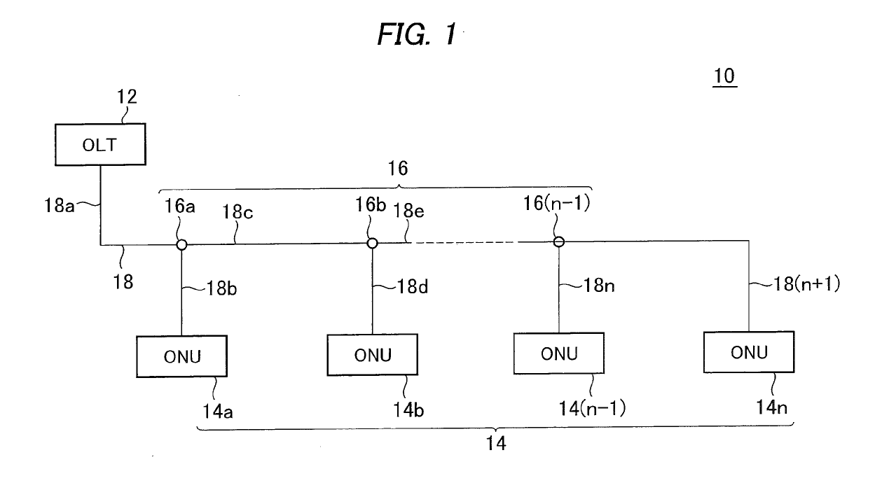

To begin with, an optical access network 10 will be described with reference to FIG. 1. FIG. 1 is a schematic network system diagram showing an illustrative embodiment of optical access network 10 configured on the basis of bus topology, to which the present invention is applied. The optical access network 10 comprises a station terminal (OLT) 12 and a plurality (n) of subscriber terminals (ONUs) 14a to 14n, where n is a natural number. In the context, transmission from the OLT 12 to the ONUs 14 may be referred to as down-stream (DS) and transmission from the ONUs 14 to the OLT 12 as up-stream (US).

In the optical access network 10 thus structured by bus topology, the OLT 12 and a plurality of optical couplers 16a to 16(n−1) are connected in series to each other by an optical fiber line 18. The ONUs 14a to 14(n−1) are connected to the respective optical couplers 16a to 16(n−1), which additionally has the ONU 14n connected also.

In case of the n-user network configured on the basis of bus topology, the (n−1) optical couplers are installed. The first optical coupler 16a is connected to the OLT 12 by a section of optical fiber line 18a. One of the two branches of the first optical coupler 16a is connected to the first ONU 14a by an optical fiber line section 18b, and the other is connected to the second optical coupler 16b by an optical fiber line section 18c. Correspondingly, one of the two branches of the second optical coupler 16b is connected to the second ONU 14b, and the other is connected to the third optical coupler, not shown, by an optical fiber line section 18e. Similarly, one of the two branches of the k-th optical coupler 16k is connected to the k-th GNU 14k, and the other is connected to the (k+1)-th optical coupler 16(k+1), where k is an integer between two and n−2, both inclusive. One of the two branches of the (n−1) -th optical coupler 16(n−1) is connected to the (n−1)-th ONU 14(n−1) by an optical fiber line section 18n, and the other is connected to the n-th ONU 14n by an optical fiber line section 18(n+1). In this way, the n-user network designed on the basis of bus topology is constituted.

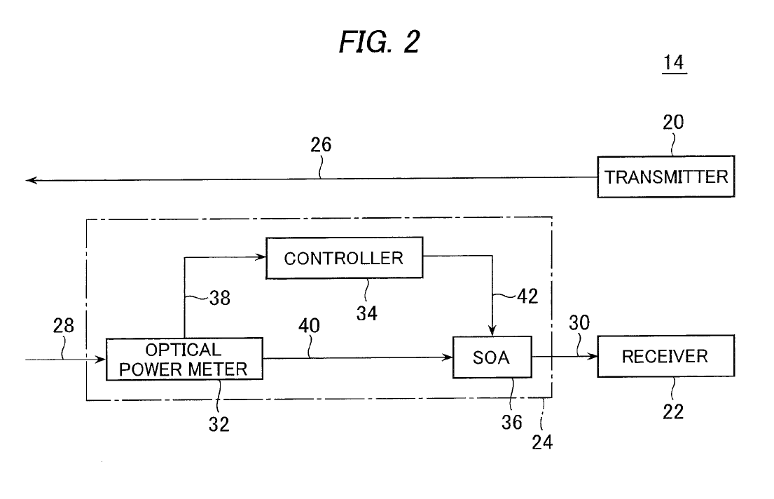

With reference to FIG. 2, description will be made on an illustrative embodiment of optical signal transmission apparatus in accordance with the present invention. FIG. 2 is a schematic block diagram of an optical communication apparatus, which can specifically be used in the ONUs 14 of the optical access network 10. For illustration, the optical communication apparatus may therefore also be designated with the reference numeral 14. The invention may not be confined to this specific embodiment. For example, the optical communication apparatus can be used in the OLT 12 of the optical access network 10. It can also be applied in use for receiving optical signals having intensity or strength fluctuating.

The ONU or optical communication apparatus 14 comprises a transmitter 20, a receiver 22 and a received-intensity controller 24, which are interconnected as illustrated. Since the transmitter 20 and the receiver 22 can be of conventionally known configuration based on the multiplex transmission system of optical access networks, such as WDM, CO-OFD or the like, detailed description thereof will be refrained from.

The transmitter 20 of the ONU 14 is adapted to transmit optical signals or light beam 26 toward the OLT 12, i.e. in the up-stream direction. In respect of receiving optical signals or light beam 28 incoming from the OLT 12 to the ONU 14, i.e. down-stream transmission, the optical signals, i.e. light beam, 28 are received by the receiver 22 in the form of optical signals 30 via the received-intensity controller 24.

The received-intensity controller 24 comprises an optical-intensity monitor 32, a controller 34 and a semiconductor optical amplifier (SOA) 36, which are interconnected as depicted.

The optical-intensity monitor 32 serves to measure or monitor the optical intensity, or power, of the received optical signal 28, i.e. received optical strength, and informs the controller 34 of a resultant measurement 38. The optical-intensity monitor 32 may be implemented by an optical power meter, which may be conventionally known optional measurement device. The optical signal 28 is conveyed to the SOA 36 as an optical signal 40 through the optical-intensity monitor 32.

The SOA 36 is in nature an optical device for amplifying an optical signal. In the context, the term “amplify” or “amplifier” may broadly be comprehended such as to cover the possibility of not only enhancing the intensity or power of an optical or electric signal with a positive gain but also attenuating the intensity or power of an optical or electric signal with a negative gain.

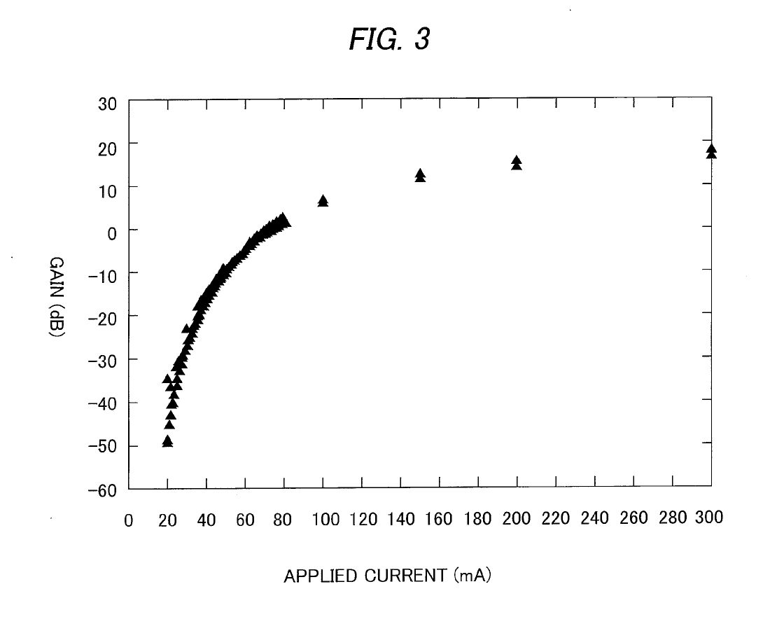

With reference to FIG. 3, the gain characteristic of the SOA 36 will be described. FIG. 3 is a graph plotting the measurements of the gain characteristic of the SOA 36, in which applied current (mA) is plotted on the axis of abscissas and gain (dB) is plotted on the axis of ordinate. This measuring was conducted with the use of, e.g. a C-Band Optical Power Booster marketed under the trade name, Kamelian, by Amphotonix, CST Global Limited, the United Kingdom.

As seen from FIG. 3, the SAO 36 has its gain which becomes negative in the order of about −50 dB when the applied current is 20 mA and increases as the applied current increases. When the applied current exceeds 70 mA, the gain becomes positive. In particular, the maximum gain will be obtained in the order of about 15 to 20 dB.

When a current of 70 mA or more is applied to the SOA 36, the gain is positive, in which case the SOA outputs the output optical intensity stronger than the input optical intensity. In that case, the SAO 36 functions as an optical amplifier amplifying the input light to produce a resultant output light thus amplified. By contrast, when a current less than 70 mA is applied, the gain is negative, in which case the SOA outputs the output optical intensity weaker than the input optical intensity. In that case, the SAO 36 functions as an optical attenuator attenuating the input light to produce a resultant output light thus attenuated.

As described above, the SAO 36 selectively functions not only as an optical amplifier but also as an optical attenuator. As such, the SOA 36 is a sort of optical amplifier having its gain for the optical intensity of the incoming light beam 28, and hence beam 40, variable or switchable in response to the intensity control signal 42 to develop an intensity-adjusted light beam 30. The optical amplifier 36 may not be restricted to a semiconductor optical amplifier so far as it has its gain switchable between positive and negative values. There is also a report that the similar characteristics can be obtained in the SAO 36 when structured by its active layer formed of InGaAs. In particular, see Annual Report 2005 by NTT Photonics Laboratories, Japan.

The received-intensity controller 34 is responsive to the received optical intensity 38 informed from the optical-intensity monitor 32 to produce an intensity control signal 42 and send the latter to the SOA 36. The intensity control signal 42 in this case takes, for example, the form of current to be applied to the SAO 36 such that the SOA 36 is responsive to the magnitude of the applied current to control the intensity of light passing therethrough. The controller 34 may optionally and suitably be implemented by an FPGA (Field Programmable Gate Array) or an MPU (Micro-Processing Unit) or the like.

In addition, the received-intensity controller 34 may preferably comprise optional and suitable storage means, such as a Read-Only Memory (ROM) or a Random Access Memory (RAM) for storing therein data representative of applied-current vs gain characteristic of the SOA 36. The controller 34 can calculate a gain value that may fall within a range defining an optical intensity receivable by the receiver 22, and uses the data of applied-current vs gain characteristic to obtain the value of applied current 42 to transfer a resultant intensity control signal to the SOA 36. That makes it possible to readily control the optical intensity receivable by the receiver 22 to its optimal level.

The instant illustrative embodiment is arranged such that the optical signal 28 received by the ONU 14 is sent to the receiver 22 via the optical-intensity monitor 32 and the SOA 36 in order. However, the configuration of the optical-intensity monitor 32 and the SOA 36 may not be confined to the specific embodiment described above. For example, the optical signal 28 received by the ONU 14 may be arranged to be sent to the receiver 22 via the SAO 36 and the optical-intensity monitor 32 in order.

In an arrangement where the optical-intensity monitor 32 is disposed downstream the SOA 36, the optical intensity of an optical signal is monitored right before input to the receiver 22. Therefore, even when the gain characteristic of the SOA 36 is changeable, for example, the optical intensity of the optical signal to be input to the receiver 22 can be easily controlled to its optimal level. However, when the optical intensity of an optical signal delivered to the optical-intensity monitor 32 is weaker, it may be difficult to determine whether the optical intensity of an optical signal received by the ONU 14 per se is weak or the gain of the SOA 36 is low.

In the arrangement where the optical-intensity monitor 32 is provided upstream the SOA 36, as shown, the optical intensity of the optical signal 28 received by the ONU 14 can be monitored independently of the gain characteristic of the SAO 36. However, when the gain characteristic of the SAO 36 is fluctuant, it may be difficult to appropriately control the optical intensity of the optical signal 30 to be received by the receiver 22 to its optimal level.

As described earlier, in the prior art receiving apparatus using an optical amplifier and an optical attenuator, it was necessary to apply, even when the intensity of an input light beam is to be attenuated, a current to the optical amplifier to amplify an optical output signal in order to enable the optical amplifier to develop an output light beam. Thus, the prior art apparatus using the optical amplifier and attenuator required current to be applied to both optical amplifier and attenuator.

By contrast, in accordance with the optical communication apparatus of the present invention, since an optical-intensity control device for use in receiving signals is solely the SOA 36, the number of constituent elements and electric consumption can thus be reduced, compared with the prior art optical communication apparatus using plural optical-intensity control devices.

Further, in the prior art apparatus using the optical amplifier and attenuator, in order to control the intensity of a received light beam to its optimal level, i.e. within a receivable range of an optical receiver when the intensity is fluctuant, it may be required to increase or decrease the gain or gains of the optical amplifier or/and attenuator, whereby control becomes complicated.

By contrast, in accordance with the present invention, the intensity of an optical signal delivered to the receiver of the optical communication apparatus is dependent upon the magnitude of a current applied to the SOA 36, thereby control being easier than the prior art apparatus.

The entire disclosure of Japanese patent application No. 2014-63808 filed on Mar. 26, 2014, including the specification, claims, accompanying drawings and abstract of the disclosure, is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. An optical communication apparatus comprising:
an optical-intensity monitor monitoring received optical intensity of an incoming light beam;
a controller operative in response to the received optical intensity for producing an intensity control signal;
an optical amplifier having a variable gain for the optical intensity of the incoming light beam in response to the intensity control signal to develop an intensity-adjusted light beam; and
a receiver having a receivable-intensity range for receiving the intensity-adjusted light beam from said optical amplifier within the receivable-intensity range.

2. The apparatus in accordance with claim 1, wherein said optical amplifier comprises a semiconductor optical amplifier operative in response to the intensity control signal for selectively amplifying or attenuating the optical intensity of the incoming light beam to develop the intensity-adjusted light beam.

3. The apparatus in accordance with claim 2, wherein said optical amplifier is responsive to an applied current to render the gain positive or negative.

4. The apparatus in accordance with claim 2, wherein said controller holds data representative of applied-current vs gain characteristic of said semiconductor optical amplifier,
said controller calculating the gain to adjust the received optical intensity to the receivable-intensity range, and using the data of the applied-current vs gain characteristic to produce an applied current as the intensity control signal to said semiconductor optical amplifier.

5. The apparatus in accordance with claim 3, wherein said controller holds data representative of applied-current vs gain characteristic of said semiconductor optical amplifier,
said controller calculating the gain for adjusting the received optical intensity to the receivable-intensity range, and using the data of the applied-current vs gain characteristic to produce an applied current as the intensity control signal to said semiconductor optical amplifier.
